(19) United States
(12) Patent Application Publication
(10) Pub. No.: US 2024/0050961 A1
(43) Pub. Date: Feb. 15, 2024

(54) PNEUMATIC DEVICE AND OBJECT SORTING SYSTEM

(71) Applicant: PHARMA FLEX, Nivelles (BE)

(72) Inventors: Freddy VANDENBROUCKE, Roux (BE); Martial DOLLINGER, Braine l’Alleud (BE)

(21) Appl. No.: 18/258,527

(22) PCT Filed: Dec. 22, 2020
(86) PCT No.: PCT/EP2020/087604

§ 371 Date: Jun. 20, 2023

(51) Int. Cl. B05B 1/00; B05B 7/12

(52) U.S. Cl. CPC B05B 1/005; B05B 7/1236

(57) ABSTRACT

The invention relates to a pneumatic device (10) comprising modules (100), each module having compressed air supply valves (12), the intensity of the compressed air jet supplied by each module (100) being variable according to the combination of valves (12) activated, and outlet nozzles (14) of one or more air jets coming from the modules (100), according to the number of modules (100) activated, the nozzles having aligned outlet orifices. The invention also relates to an object sorting system comprising the pneumatic device.

### TECHNICAL FIELD

The present invention relates to a pneumatic device and an object sorting system comprising the pneumatic device.

### BACKGROUND

The increasing of the production rates of objects, for example in the pharmaceutical industry, require resources to ensure a high level of quality. There is also a growing desire to inspect an entire population of objects rather than just a sample. For this purpose, there are on-line object analysis devices that allow to precisely measure each of their physical quantities and compositions. Once the objects have been analysed, a decision is taken whether or not to keep the objects; the objects that are not kept are excluded from the production lines. Given the speed of production, the problem is that there is very little time to perform the sorting of the objects.

The document US20160016200 describes a pneumatic device for sorting products in the food industry, such as seeds or grains of rice or wheat. The device comprises solenoid valves each having a series of air jet orifices. The solenoid valves each comprise an air inlet in a compartment; the air is then distributed to each orifices via a respective valve opened by the electrification of a coil or held closed by a resilient member. However, as the pneumatic device in this document is intended for sorting seeds, it has a large number of orifices expelling jets of air, all of which must have the same volume. This makes it bulky and imprecise.

There is therefore a need for a device that allow sorting the objects quickly and accurately, while limiting the overall dimension required.

### DESCRIPTION OF THE INVENTION

To this end, the invention proposes a pneumatic device comprising
modules, each module having valves for supplying compressed air, the intensity of the compressed air jet delivered by each module being variable according to the combination of valves activated,
outlet nozzles for discharging one or more air jets coming from the modules, according to the number of modules activated, the nozzles having aligned outlet orifices.

In one variant, the modules are in a fan-like pattern relative to the nozzles.

In one variant, the modules have respectively a conduit directing the compressed air from the valves towards the nozzles, with the valves on either side of the conduit with respect to the flowing orientation of the compressed air in the conduit.

In one variant, the valves are connected to the conduit by an orifice, each valve having a different orifice diameter.

In one variant, the valves are arranged along the conduit according to the diameter of the orifices, the valve with the smallest diameter orifice being at the distal end of the conduit from the nozzles.

In one variant, the device comprises six modules, each module comprising at least four valves, preferably five valves.

In one variant, the device also comprises a pressure sensor at the inlet of the modules, capable of measuring the pressure losses caused by successive openings of the valves.

The invention also relates to a system for sorting objects, comprising at least one pneumatic device as described above.

According to one variant, the system also comprises a channel guiding the objects along a direction of travel, the nozzles directing one or more air jets in the channel towards the objects to be sorted according to the characteristics of the objects to be sorted.

In one variant, the width of the channel can be adjusted transversely to the direction in which the objects are travelling, depending on the characteristics of the objects.

In one variant, the system also comprises
a chamber for analysing the characteristics of the objects to be sorted
at least one sorting pathway towards which the objects are deflected by actuating one or more air jets according to the characteristics analysed in the analysis chamber.

In one variant, the system also comprises a control unit that activates all or some of the modules and of the valves as a function of the characteristics of the objects analysed in the analysis chamber.

In one variant, the control unit activates all or some of the modules and of the valves as a function of the pressure available upstream of the valves.

The use of the verb “comprise” and its variants, as well as its conjugations in this document, cannot in any way exclude the presence of elements other than those mentioned.

The use in this document of the indefinite article “a”, “an”, or the definite article “the” to introduce an element does not exclude the presence of a plurality of these elements.

The terms “first”, “second”, “third”, etc. are used in this scope of this document exclusively to differentiate between different elements, without implying any order between these elements.

All the preferred embodiments and all the advantages of the pneumatic device apply mutatis mutandis to the sorting system.

### BRIEF DESCRIPTION OF THE FIGURES

Further characteristics and advantages of the present invention will become apparent from the following detailed description, for the understanding of which reference is made to the attached figures which show:

FIG. 1, a schematic view of a part of a pneumatic device according to an example of the invention;

FIG. 2, a cross-sectional view of the device;

FIG. 3, a rear view of the device shown in FIG. 2;

FIGS. 4 and 5, perspective views of a sorting system according to one example of the invention;

FIG. 6, a schematic view from the top of the sorting system;

FIG. 7 shows a schematic view of the sorting system.

The drawings in the figures are not to scale. Similar elements are generally denoted by similar references in the figures. In the scope of this document, the same or similar elements may have the same references. Furthermore, the presence of reference numbers or letters in the drawings cannot be considered as limiting, even when these numbers or letters are indicated in the claims.

### DETAILED DESCRIPTION OF EMBODIMENTS OF THE INVENTION

The invention relates to a pneumatic device, comprising modules, each module having valves for supplying compressed air. The intensity of the compressed air jet delivered by each module is variable according to the combination of valves activated. The device also comprises outlet nozzles for discharging one or more air jets coming from the modules, depending on the number of modules activated, the nozzles having aligned outlet orifices. Such a device combines the adjustment of the number of air jets at the outlet with the intensity of the air jets. This allows to apply a deflection force to objects that need to be sorted very quickly, with an accuracy adapted to the characteristics of the objects, while limiting the overall dimension of the device.

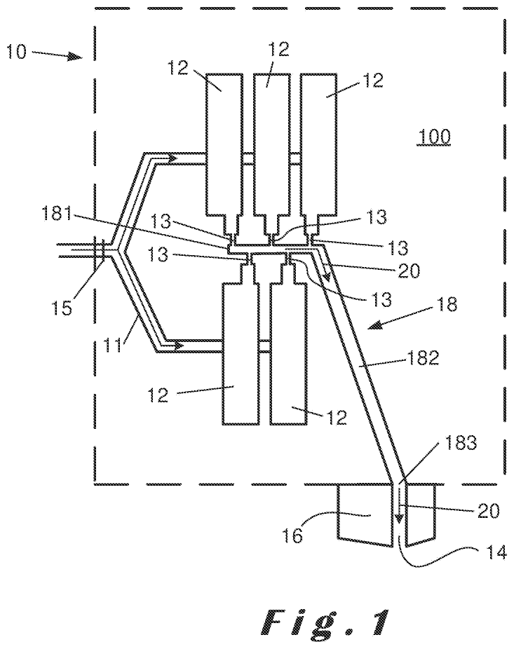

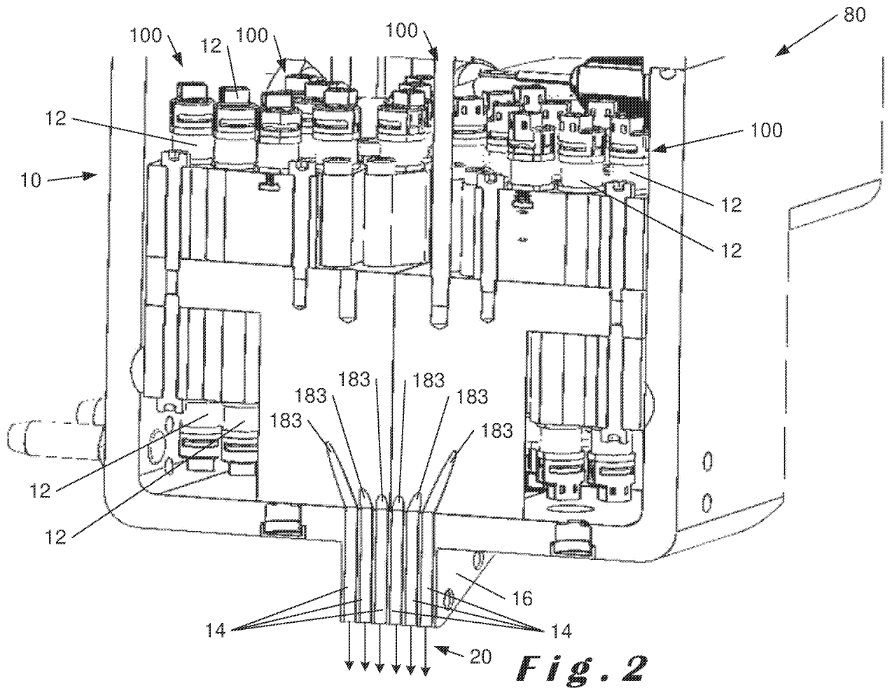

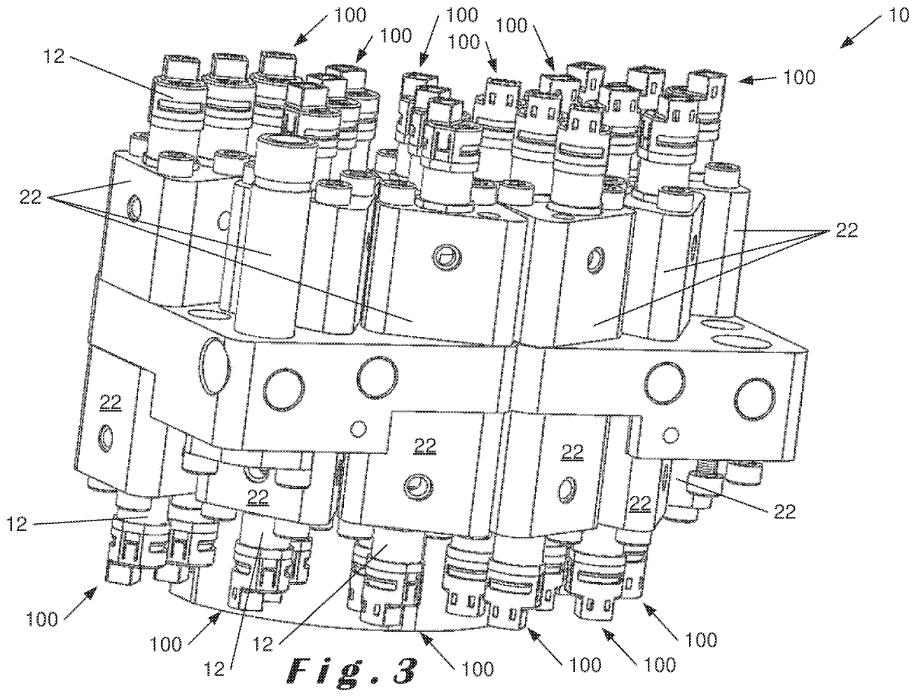

FIG. 1 shows a schematic view of a part of the pneumatic device 10. The device 10 comprises modules, of which only the module 100 is shown. Other modules comprising the same elements are shown in FIGS. 2 and 3. The module 100 comprises a plurality of valves 12, for example four or five in number, as shown in FIG. 1. The valves are supplied with compressed air from a tank of sufficient volume (minimum 5 litres, maximum 15 litres), the pressure of which is regulated precisely by a precision pressure regulator; this ensures the most stable possible supply to the valves 12. In FIG. 1, the valves 12 are supplied via a supply conduit 11. At the inlet of the supply to the modules 100, a pressure sensor 15 on the supply conduit 11 is able to measure the pressure losses caused by successive openings of the valves. The pressure sensor 15 allows to correct the opening of the valves 12 as a function of the pressure present at the inlet. The valves 12 may or may not be identical within a module or from one module to another. When the valves are the same, this allows to make it easier to control the valves; different valves allow even finer control. The valves 12 can be of different types, such as proportional valves, but preferably “on/off” type valves. The “on/off” valves are highly responsive, which is an advantage when objects are travelling at high speed. These “on/off” valves are also smaller in size. It is preferable to use a plurality of smaller valves rather than one larger valve capable of making pass a large flow rate at full opening. In fact, there are more forces to overcome to open a large valve (return force of the springs, inertia of the masses of the spools and other movable elements to be set in motion, and friction of the seals) so that the opening or closing times are, for example, of the order of a few milliseconds. In order to produce air jets in very small “firing windows”, the opening time of the valves 12 is less than 3 ms, preferably less than 2 ms, more preferably less than 1 ms.

The module 100 also comprises an outlet nozzle 14 for discharging the air jet coming from the module 100. The intensity of the single compressed air jet delivered by each module 100 is variable according to the combination of valves 12 activated. The modules 100 can be selectively activated and, within each module 100, the valves 12 can be selectively activated. Each jet is therefore proportional to the characteristics of the objects to be sorted. The nozzle 14 allows the air jet specific to each module to be optimally positioned in relation to the objects to be sorted. The nozzle is a conduit machined into a casing 16, the casing 16 then being attached to the module. The geometry of the outlet orifice of the nozzle is chosen according to the characteristics of the air jets. A non-circular geometry, such as an oval, may be advantageous. The set of nozzles can be an interchangeable modular element of the device 10 in order to adapt to the conditions of use of the device and the objects to be sorted. The diameter of the outlet orifice of the nozzle is between 1 mm and 8 mm, preferably between 2 mm and 5 mm, more preferably between 2.5 mm and 4 mm, for example 3 mm, to obtain a jet of air per module allowing for an efficient sorting.

The module 100 also comprises a conduit 18 directing the compressed air from the valves towards the nozzle 14. The arrow 20 indicates the flowing orientation of the air through the conduit 18 to the outlet of the nozzle 14. The valves can be positioned along the conduit 18 within a module. Preferably, the valves 12 are on either side of the conduit 18 with respect to the flowing orientation of the compressed air in the conduit 18 within a module; in other words, the valves are opposite each other (without necessarily facing each other) or on either side of the conduit 18. Such a mounting of the valves allows to reduce the volumes required in the device (both the space occupied by the valves and the volumes of the conduits). The conduit 18 is therefore more compact at the level of the valves 12.

The conduit 18 may comprise several stretches arranged to take account of the overall dimension of the valves within the module. These stretches also allow to arrange the valves within a module and the modules in relation to each other, ensuring the same pressure loss between the different modules. The length of the conduit 18 is as short as possible to minimise the distance between the outlet orifices of the valves and the outlet orifices of the nozzles.

The conduit may comprise a first stretch 181 to which the valves 12 are connected as described above. The conduit 18 may comprise a second stretch 182 connecting the first stretch 181 at its end to the nozzle 14. The arrangement of the second conduit 182 within the module is chosen so as to reduce the overall dimensions of the modules within the device. The second stretch 182 can be oblique with respect to the first stretch 181, and is preferably straight, which generates less pressure loss. The diameter of the conduit 181 is between 2 and 5 mm, preferably between 2.5 and 4 mm, for example 3 mm, and the diameter of conduit 182 is between 3 and 6 mm, preferably between 3.5 and 5 mm, for example 4 mm—this ensures an air jet at the outlet of the device, allowing objects to be sorted efficiently while limiting the overall dimensions of the conduits. The conduit 18 opens out at its end 183 at the outlet of the module 100; the nozzle 14 is positioned at the end 183 of the module 100 and precisely directs the compressed air jet specific to each module towards the objects to be sorted.

The valves 12 are connected to the conduit 18, in particular to the first stretch 181, by outlet orifices 13. Each valve has a different orifice diameter 13. There may be a relationship between these conduits 13, in terms of diameter or area. This allows the intensity of the air jets to be varied. Within a module 100, if ‘x’ is the number of valves 12, 2″ is the number of possible valve opening combinations, one of which corresponds to all the valves being closed. Within the module 100, the valve 12 with the smaller diameter orifice is at the distal end of the conduit 18 with respect to the nozzles 14; this allows to prevent the air flow propelled by the valves with a smaller diameter orifice into the conduit 18 from being disturbed by the turbulence of an air flow propelled by valves with a larger diameter orifice.

The outlet orifices of the valves are between 0.4 and 3 mm, preferably between 0.5 and 2.5 mm. This allows compressed air to be released quickly into the conduit 18, while limiting the overall dimension of the valves.

FIG. 2 shows a cross-sectional view of the pneumatic device 10. The device 10 is mounted in a casing 80. The nozzles 14 are shown at the outlet of the device 10, expelling jets of air 20, and are connected to the ends 183 of the conduits 18 supplied by the valves 12. The orifices of the nozzles 14 are aligned. The orifices of the nozzles 14 are in the same plane. The orifices of the nozzles have a spacing (between the central axes) of between 3 and 5 mm, preferably between 3.5 and 4.5 mm, and even more preferably 4 mm, to ensure that the nozzle is compact and that the air jets allow an effective sorting. The outlet orifices of the nozzles 14, each orifice corresponding to a module 100 comprising several valves 12, are such that the arrangement of the jets is flat or, in other words, the air jets form a flat curtain. The area over which the jets act from the orifices and in the direction of the jets is from 5 to 50 mm, preferably from 10 to 35 mm, i.e. an area of 25 mm. This allows the device to be compact, while providing enough space to provide a number of jets, corresponding to the number of modules, to suit the characteristics of the objects to be deflected.

The arrangement of the valves 12 within the modules 100 on either side of the conduit 18, and in particular the conduit 182, is particularly advantageous for limiting the overall dimensions of the device 10. FIG. 2 shows a part of the valves 12 in the upper part of the modules 100 and a part of the valves 12 in the lower part of the modules 100. As shown in FIGS. 1 and 2, three valves 12 are at the upper part and two valves are at the lower part of the modules 100.

The modules 100 can be arranged in a fan-like pattern relative to the nozzles 14. In other words, the modules 100 are arranged in orange segments relative to the nozzles 14. This can be seen at the top of FIG. 2, where three valves 12 from each module 100 are aligned radially around the nozzles. This allows the modules 100 to be arranged identically in relation to each nozzle 14, while ensuring that the device 10 is compact inside the casing 80. This allows to guarantee exactly the same airflow channels for each nozzle, in terms of length, geometry and volume. The modules 100 can be of modular construction; one or more modules are used depending on the desired performance of the device 10 and the modules can be grouped together. The modules 100 can be built in groups of several modules. This makes the device 10 easier to manufacture. In addition, the modules 100 are identical from a “pneumatic” point of view in that the valves 12 on the modules are connected in the same way to the outlets of the nozzles from one module to the other. There is therefore the same response time for the formation of each air jet. The modular construction also means that smaller parts can be manufactured in greater numbers. The modular construction of the modules 100 can also be in groups of several modules 100, for example three modules 100 grouped together.

FIG. 3 shows a rear view of the device shown in FIG. 2, in which the fan-shaped arrangement of the modules 100 is more clearly visible. The valves 12 in each module 100 are aligned along radii that converge towards the nozzles (not visible). As shown in the example in FIG. 3, the modules 100 have three valves 12 at the upper part and two valves 12 at the lower part; the five valves 12 in each module 100 are arranged in fan-shaped planes around the nozzles 14. The valves 12 can be arranged on bars 22.

The invention also relates to an object sorting system comprising the pneumatic device 10. The objects to be sorted may be nominal objects (nominal sample diverted towards the test station) or non-conforming objects (debris, capsules with little or no filling, etc.). By combining the selective activation of the number of modules and of the number of valves within each module, the air jets are adapted to the objects so that the objects can be sorted efficiently. Such a system can be used in the pharmaceutical industry to divert objects as pharmaceutical tablets or capsules (soft-gels, empty or filled), from 20 mg to several grams.

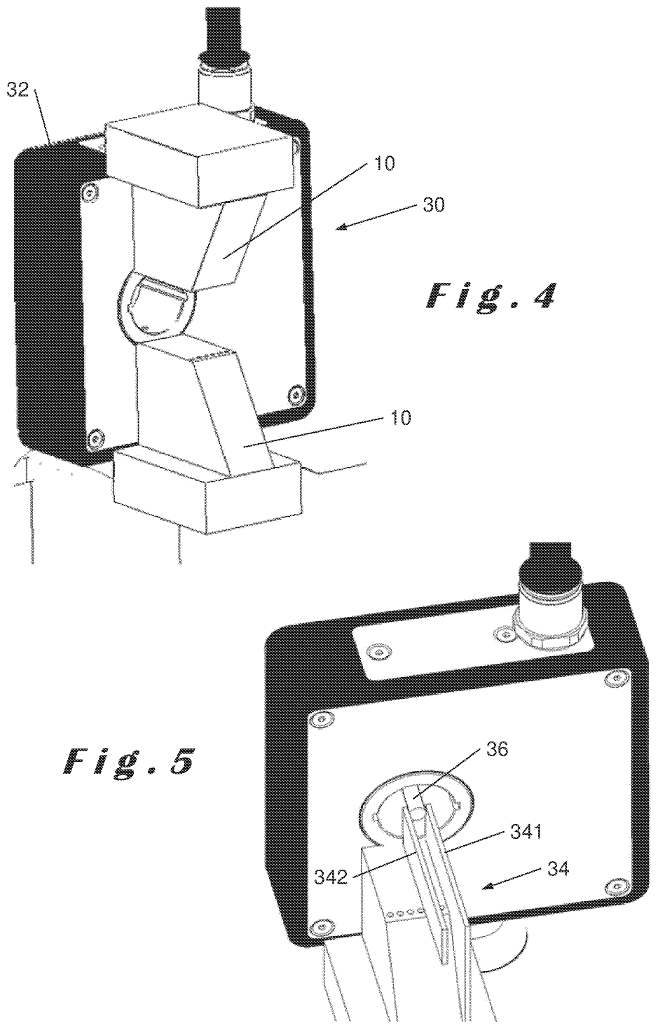

FIGS. 4 and 5 show perspective views of the sorting system 30. The system comprises a chamber 32 for analysing the characteristics of the objects to be sorted. The chamber 32 analyses all the objects, the pneumatic device 10 being able to deflect the objects according to the characteristics analysed in the analysis chamber 32. A control unit selectively activates all or some of the modules 100 and valves 12 depending on the characteristics of the objects analysed in the analysis chamber 32. The objects can be accelerated to pass individually through the chamber 32 in front of a microwave sensor which allows the prediction of their mass and/or their moisture content, and which precedes the sorting device. This measurement chamber 32 allows also to quantify the speed of the objects and the time at which they arrive at the sorting jets. The objects travel in a line at high speed—between 5 m/s and 25 m/s. The objects exit the chamber 32 through the tube 36. The objects travel past the device 10, which operates the deflection of the objects according to non-conformity or other criteria detected in the chamber 32. The orifices of the nozzles 14 are aligned along an axis transverse to the direction in which the objects are travelling. This allows the objects to be intercepted efficiently. The air jets then form a plane, or curtain, transverse to the direction in which the objects are travelling. A plurality of devices 10 can be used. For example, two (FIG. 4), three or even four devices 10 can be used, in order to better adapt to the sorting rates imposed by the speed at which the objects travels. One of the devices 10 may be dedicated to the deflection of the non-conforming objects and another device 10 dedicated to the test sampling (possibly in addition to a systematic analysis in chamber 32). The devices 10 can be arranged around the direction of travelling of the objects, for example one above the other, on either side of the travel of the objects.

The system can comprise a channel 34 for guiding objects at the outlet of the chamber 32 in a direction of travel. The channel 34 allows the objects to be conveyed in a queue along a virtually straight trajectory. This allows the objects to be presented one by one to the device 10, making them easier to deflect. The channel comprises two flat surfaces 341 and 342 to guide the objects.

The width of the channel 34 can be adjusted transversely to the direction of travel of the objects to be sorted. The width of the channel is adjustable in the direction of alignment of the nozzles 14. The space between the flat surfaces 341, 342 is adjusted to the width of the objects to be sorted. The channel 34 can be adjusted so as to direct objects with a width of between 3 mm and 25 mm, depending on the format of the product to be sorted. The nozzles 14 direct one or more jets of air in the channel 34 towards the objects to be sorted, depending on the characteristics of the objects to be sorted.

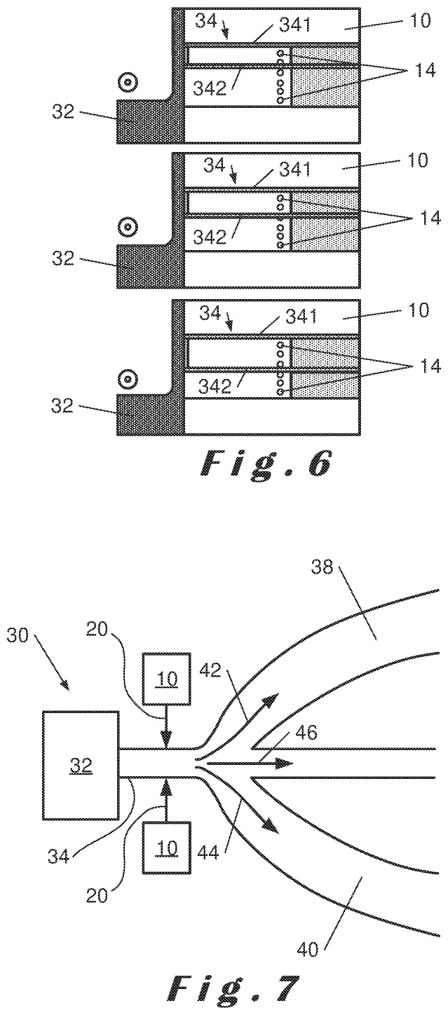

FIG. 6 shows a schematic view from the top of the sorting system 30. FIG. 6 shows how the air jets can be adapted to the objects according to their width, by varying the number of modules activated—in addition to the fact that the intensity of each jet varies according to the combination of valves activated within each module. At the outlet of the chamber 32, the objects are conducted into the channel 34, between the flat surfaces 341 and 342. For narrow objects, the flat surfaces are brought as close together as possible so that a single nozzle 14 directs the air jet from the device 10 into the channel 34. A single module 100 is then activated. For larger objects, the flat surfaces are spaced apart so that two nozzles 14 direct the air jet from the device 10 into the channel 34. For even wider objects, the flat surfaces are spaced further apart so that three nozzles 14 direct the air jet from the device 10 into the channel 34. According to the example in FIG. 6, up to six nozzles 14 can dispense air jets, corresponding to the activation of six modules 100. The width of the channel 34 is, for example, between 5 and 50 mm, preferably between 5 and 30 mm, more preferably between 5 and 25 mm, to suit the number of air jets. The device 10 and the sorting system 30 allow to generate a jet of variable width and intensity. This variation makes the system 30 versatile, adaptable to objects of varying mass, size, geometry, speed, etc.

FIG. 7 shows a schematic view of the sorting system 30, in particular with one or more sorting pathways 38, 40. At the outlet of the chamber 32, the objects are guided by the channel 34 and then pass in front of the nozzles of one or more devices 10. The objects to be deflected pass through the air jets 20 forming a curtain. The device or devices 10 divert the objects to one or other of the sorting pathways—according to the arrows 42, 44—due to an inconclusive sampling test or compliance test. The unsorted objects continue their trajectory along the arrow 46. According to FIG. 7, the deflection is operated in the vertical plane; a device 10 can be placed above the travel of the objects to deflect them towards a lower pathway 40 and another device 10 can be placed below the travelling of the objects to deflect them towards an upper pathway 38. The sorting can be done in a horizontal plane.

The distance between the outlet of the chamber 32 and the position of the nozzles 14 is chosen so as to allow the object time to exit the chamber 32 before being deflected if necessary. Otherwise, the object could already be subjected to a transverse force while it is still partially conducted and guided by the tube 36, thus risking hindering the deflection of the object.

The number of air jets and the intensity of each air jet produced by a respective module 100 are variable according to an input setpoint coming from the control unit. The setpoint determines the number of modules 100 activated and the combination of valves 12 activated within each module 100. The operation of each jet will therefore be proportional to this setpoint. This setpoint is calculated as a function of several characteristics analysed in the chamber 32. The mass of the objects is taken into account, with a different combination of valves 12 being activated to increase or decrease the intensity of the jet. The speed of the objects is also taken into account, as is the moment at which the object reaches the height of the jets. The shape and the volume of the objects also influence the number and the intensity of air jets activated and the width of the channel 34. The force to be applied to the object and the pressure upstream of the valves are also taken into account to avoid damaging the objects. This allows to maintain the quality of the sorting even if the tanks are not able to recover their nominal pressure as quickly in cases where several openings occur close together in time. The distance between the device 10 and the objects to be sorted is a factor to be taken into account to guarantee the efficiency of the sorting. The distance between the outlet of the jet (outlet orifices of the nozzles 14) and the axis of displacement of the objects is between 10 and 40 mm, preferably between 15 and 30 mm, for example 20 mm. This allows the objects to be deflected to be presented to the jet in an area where the deflection will be most effective, while preserving the integrity of the objects to be deflected.

The control unit comprises a PLC (Programmable Logic Controller), an input/output board with highly responsive digital outputs (comprising an on-board FPGA (field-programmable gate array) processor), and a power control board (equipped with FPGA controllers and MOSFETs (Metal Oxide Semiconductor Field Effect Transistor)). This architecture allows reaction times of a few microseconds, and ensures a sorting process with valve opening or closing times of the order of a few milliseconds.

The sequence for establishing an air jet is as follows. The PLC controls the opening of the valves 12. The digital output which activates the valve or valves 12 is switched on. The time that elapses from the command depends on the architecture of the control system in place (PLC programming and cycle times, communications between the PLC and the digital output card, type of digital output card, etc.). This can take up to 1 millisecond. The current then builds up in the actuating coil of the respective valves, until it reaches a sufficient force to start displacing the movable parts of the valves (for up to a few milliseconds); depending on the combination of the valves, the controlled valves open and the air starts to flow. Depending on the geometry of the conduits and of the nozzle, the air will take some time to emerge from the orifices of the nozzles. Finally, the jet is established. First, there are the transient phenomena over a short period of time, before reaching a stable jet. The time lapse between the activation signal and the moment when the jets are fully established is less than 5 ms, preferably less than 4 ms, more preferably less than 3 ms, most preferably less than 2 ms.

Under the effect of the air jet or jets, the objects are deflected from their substantially straight course towards the sorting pathway or pathways 38, 40. Thanks to the sorting pathways 38, 40, the device 10 and the adaptation of the number and of the intensity of the air jets, the deflected objects are not damaged. These objects can be subject to a new compliance check in which a device 10 can be implemented again; the objects can be returned to the main circuit because they have not been damaged.

The present invention has been described above in connection with specific embodiments, which are illustrative and should not be considered limiting. In general, it will be apparent to a person skilled in the art that the present invention is not limited to the examples illustrated and/or described above.

1. A pneumatic device, comprising
modules, each module having valves for supplying compressed air, the intensity of the compressed air jet delivered by each module being variable as a function of the combination of valves activated,
outlet nozzles for discharging one or more air jets coming from the modules, according to the number of modules activated, the nozzles having aligned outlet orifices.

2. The device as claimed in claim 1, wherein the modules are in a fan-like pattern relative to the nozzles.

3. The device according to claim 1, wherein the modules have respectively a conduit directing the compressed air from the valves towards the nozzles, the valves being on either side of the conduit with respect to the flowing orientation of the compressed air in the conduit.

4. The device according to claim 3, wherein the valves are connected by an orifice to the conduit, each valve having a different orifice diameter.

5. The device according to claim 4, wherein the valves are arranged along the conduit according to the diameter of the orifices, the valve with the orifice of smallest diameter being at the distal end of the conduit with respect to the nozzles.

6. The device according to claim 1, comprising six modules, each module comprising at least four valves, preferably five valves.

7. The device according to claim 1, further comprising a pressure sensor at the inlet of the modules, capable of measuring the pressure losses caused by successive opening of the valves.

8. A system for sorting objects, comprising at least one pneumatic device, the pneumatic device, comprising
modules, each module having valves for supplying compressed air, the intensity of the compressed air jet delivered by each module being variable as a function of the combination of valves activated,
outlet nozzles for discharging one or more air jets coming from the modules, according to the number of modules activated, the nozzles having aligned outlet orifices.

9. The system according to claim 8, further comprising a channel guiding the objects along a direction of travel, the nozzles directing one or more air jets in the channel towards the objects to be sorted according to the characteristics of the objects to be sorted.

10. The system as claimed in claim 9, wherein the channel as a width which can be adjusted transversely to the direction of travel of the objects as a function of the characteristics of the objects.

11. The system according to claim 8, further comprising
a chamber for analysing the characteristics of the objects to be sorted
at least one sorting pathway towards which the objects are deflected by actuating one or more air jets according to the characteristics analysed in the analysis chamber.

12. The system according to claim 11, further comprising a control unit activating all or some of the modules and of the valves as a function of the characteristics of the objects analysed in the analysis chamber.

13. The system as claimed in claim 12, wherein the control unit activates all or some of the modules and of the valves as a further function of the pressure available upstream of the valves.
